(19) United States
(12) Patent Application Publication
(10) Pub. No.: US 2008/0197119 A1
(43) Pub. Date: Aug. 21, 2008

(54) Method for Welding a Sintered Shaped Body

(75) Inventors: Peter Orth, Stadl-Paura (AT); Raimund Ratzi, Wels (AT)

Correspondence Address: COLLARD & ROE, P.C., 1077 NORTHERN BOULEVARD, ROSLYN, NY, 11576, US

(73) Assignee: MIBA SINTER AUSTRIA GMBH, Laakiirchen (AT)

(21) Appl. No.: 11/597,461

(22) PCT Filed: Apr. 13, 2005
(86) PCT No.: PCT/AT05/00125

§ 371 Date: Nov. 22, 2006

(30) Foreign Application Priority Data
May 26, 2004 (AT) 904/2004

(51) Int. Cl. B23K 26/12

(52) U.S. Cl. 219/121.64

(57) ABSTRACT

A method is described for welding a sintered molded body (1) which comprises a residual porosity and which is molten in the region of the later weld seam (3) by a laser beam (4). In order to obtain dense weld seams it is proposed that during the melting of the molded body (1) the atmospheric oxygen is bound at least substantially by a deoxidizer from the pores of the molded body (1) in the area of the weld seam and is embedded in the form of finely dispersed oxides in the weld seam (3).

### 1. FIELD OF THE INVENTION

The invention relates to a method for welding a sintered molded body which comprises a residual porosity and which is molten in the region of the later weld seam by a laser beam.

### 2. DESCRIPTION OF THE PRIOR ART

Molded bodies made of sintered steel can principally be joined to other steel components by welding, which occurs irrespective of whether or not such components were produced by means of powder metallurgy. It has been seen however that the weld seams which are obtained by melting of the sinter material by a laser beam have a comparatively high porosity and therefore do not meet higher requirements placed on the strength.

### SUMMARY OF THE INVENTION

The invention is thus based on the object of providing a method for welding a sintered molded body with residual porosity with the help of a laser beam of the kind mentioned above in such a way that in joining two weldable components, of which at least one comprises a sintered molded body, weld seams are obtained which with respect to their strength are comparable to weld seams between non-sintered components.

This object is achieved by the invention in such a way that during the melting of the molded body the atmospheric oxygen is bound at least substantially by a deoxidizer from the pores of the molded body in the weld seam area and is embedded in the form of finely dispersed oxides in the weld seam.

The invention is based on the object that atmospheric oxygen leads to reactions in the area of the later weld seams in the pores of the sintered molded body during the melting of the molded body, which reactions are linked to a foaming of the melt, so that the foaming reaction is suppressed by the binding of said atmospheric oxygen and a substantially dense weld seam can be obtained. For this reason, deoxidizers are used which bind the atmospheric oxygen into oxides from the pores of the molded body during the melting of the molded body, which oxides are embedded in a finely dispersed manner in the weld seam and do not have any disadvantageous influence on the strength of the weld seam.

In order to bind the atmospheric oxygen from the pores of the sintered molded body by a deoxidizer, the deoxidizer in the form of powder can be injected by means of a protective gas into the melt of the weld seam, where it will melt as a result of the high temperatures in the plasma of the laser beam and is entrained into the depth of the weld seam by the movement of the melt in order to bind excessive atmospheric oxygen in form of finely dispersed oxides.

Another possibility to provide the deoxidizer during the melting of the weld seam area for binding the atmospheric oxygen from the pores of the sintered molded body is to embed the deoxidizer in a finely dispersed manner in the molded body before the sintering at least in the area of the later weld seam, so that during the melting of the sintered molded body the deoxidizer which is already embedded in the area of the later weld seam can become effective in the described manner. Finally, the deoxidizer can be applied onto the welded molded body in the form of a coating of the later weld seam area, which also leads to the consequence that after the joining of the components to be welded a sufficient amount of deoxidizer is available in the melting area in order to suppress a foaming of the melt.

When choosing the deoxidizer it is necessary to ensure that the binding energy towards oxygen is higher than towards the alloy elements of the sintered molded body. Furthermore, no disadvantageous effects on the properties of the weld seam should occur by the incorporation in the weld seam of the formed oxides. When silicon and/or titanium or one of their compounds are used as a deoxidizer in connection with steel sintered materials, these conditions can be fulfilled in an advantageous manner. Especially silicon counteracts an embrittlement of the weld seam and extends the weldability towards higher carbon contents of the sintered steel.

When the molded body is welded with the help of a defocused laser beam, the sintered material is molten in a higher width with the effect that melt can continue to flow from the boundary region to the depth of the weld seam, thus allowing for a favorable weld connection over the required weld depth. Notice must be taken in this connection that as a result of the residual porosity of the sintered molded body a reduction in the volume in the area of the weld seam is obtained after the solidification of the molten sintered material.

The joining of sintered molded bodies by welding requires dry subjects which are free from oil and grease in the area of the weld seam. In order to avoid having to fear any enrichment of oxygen in the pores of the cleaned surfaces during the cleaning of the molded body in preparation of the welded connection, the sintered molded body can be cleaned prior to welding by a heat treatment in a reducing protective gas atmosphere or in a low-oxygen atmosphere. Oil-free and grease-free surfaces of the sintered molded body can be obtained by annealing under a reducing protective gas or by flashing off under deficiency of air without introducing additional atmospheric oxygen into the cleaned pores.

### BRIEF DESCRIPTION OF THE DRAWINGS

The method in accordance with the invention will be explained below by reference to the enclosed drawings, wherein:

FIG. 1 shows an apparatus for welding a sintered molded body in a schematic view;

FIG. 2 shows a weld seam between a non-sintered and a sintered molded body, with the weld seam being produced according to the method in accordance with the invention and the deoxidizer being incorporated in the sintered molded body in a finely dispersed manner;

FIG. 3 shows a representation of a weld seam in accordance with FIG. 2, with the deoxidizer being embedded in a boundary zone of the molded body which receives the weld seam;

FIG. 4 shows a further representation of a weld seam, with the sintered molded body comprising the deoxidizer as a coating.

### DESCRIPTION OF THE PREFERRED EMBODIMENTS

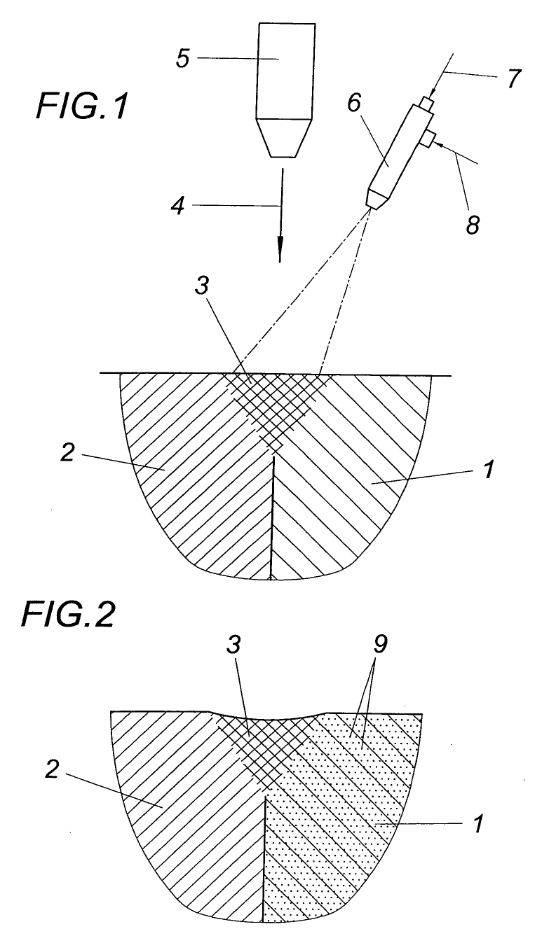

According to the illustrated embodiment, a sintered molded body 1 is joined to a non-sintered component 2 by means of welding, such that the materials of the sintered molded body 1 and the non-sintered component 2 are fused in the region of the later weld seam 3 by a preferably defocused laser beam 4 of a laser head 5, as is shown in FIG. 1. Since during the melting of the sintered material of the molded body 1 the atmospheric oxygen from the pores of the molded body 1 produces a foaming of the melt, a porous weld seam is obtained, unless special precautions are taken in order to prevent the foaming of the melt. For this purpose a deoxidizer is used which reacts with the atmospheric oxygen from the pores of the molded body 1 during the melting of the sintered material and forms oxides which are incorporated into the weld seam 3 in a finely dispersed manner without impairing the strength of the weld seam 3. By using a respective oxidizer, dense weld seams 3 can be obtained which are certainly comparable with weld seams between two non-sintered components with respect to their strength.

According to FIG. 1, the deoxidizer, e.g. silicon, is blown in powder form onto the melt in the region of the laser beam, which occurs with the help of a protective gas in order to prevent the introduction of additional atmospheric oxygen. A nozzle 6 is provided for injecting the powdery deoxidizing agent into the melt, to which the powder of the deoxidizer is supplied in a dosed manner via line 7 on the one hand and which is connected on the other hand to a pressure line 8 of a protective gas, so that the powdery deoxidizer can be injected with the help of the protective gas into the melt. The deoxidizer is molten in the melt as a result of the high temperatures in the plasma of the laser beam and entrained by the movement of the melt into the depth of the weld seam where it combines with the oxygen from the pores into oxides which are embedded into the weld seam in a finely dispersed manner. The depth to which the deoxidizer penetrates depends on the welding depth, the welding speed and the shape of the weld seam and can be set via these parameters.

In order to ensure that the deoxidizer is evenly distributed over the melting region of the sintered material, the deoxidizer can be embedded in a finely dispersed manner in the molded body 1 by a respective mixing of the sinter powder with the powder of the deoxidizer. The finely dispersed deoxidizer is indicated by dots 9 in FIG. 2. In order to avoid undesirable reactions between the sinter powder and the deoxidizer during the sintering of the molded body it is necessary to choose respective deoxidizers. Furthermore, it is necessary to take into account a potential reaction of the deoxidizer with the sinter powder during the sintering process when dosing the deoxidizer in order to enable providing a sufficient quantity of deoxidizer for binding the oxygen from the pores during the melting of the sintered material by the laser beam. The quantity of deoxidizer required for binding the oxygen naturally depends on the residual porosity and thus on the quantity of the atmospheric oxygen to be bound.

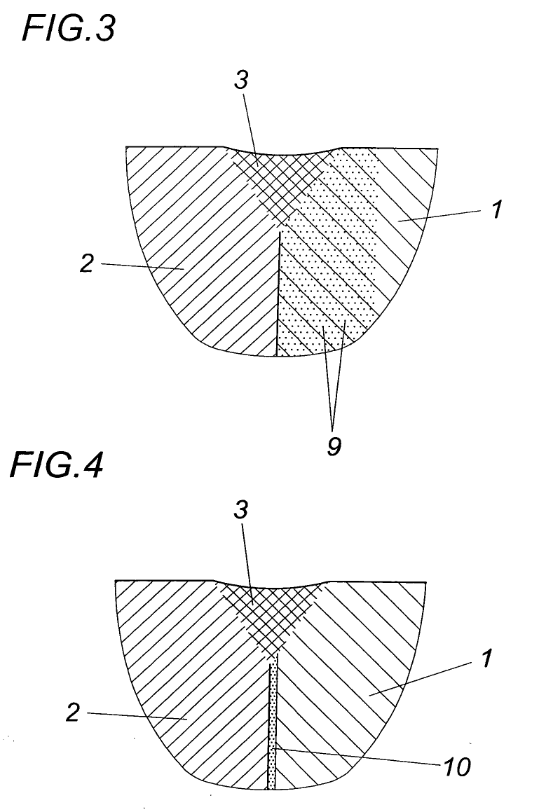

According to FIG. 3, the region of the deposits 9 of the deoxidizer in the sintered molded body 1 is limited to a boundary zone containing the weld seam 3, so that any reactions of the deoxidizer with the sinter powder during the sintering of the molded body 1 are limited to this boundary zone only.

According to FIG. 4, the deoxidizer is applied in the form of a coating 10 onto the molded body 1. As a result of said coating 10, sufficient deoxidizer is available during the melting of the sintered material in order to bind the atmospheric oxygen from the pores of the sintered material and to prevent any foaming of the molten material.

Although the embodiments merely show welded connections between a sintered molded body 1 and a non-sintered component 2, the method in accordance with the invention is not limited to the joining of sintered and non-sintered construction parts. It is understood that also two sintered molded parts can be joined with each other in the described manner by welding.

1. A method for welding a sintered molded body which comprises a residual porosity and which is molten in the region of the later weld seam by a laser beam, wherein during the melting of the molded body the atmospheric oxygen is bound at least substantially by a deoxidizer from the pores of the molded body in the weld seam area and is embedded in the form of finely dispersed oxides in the weld seam.

2. A method according to claim 1, wherein the deoxidizer is injected in powder form by means of a protective gas into the melt of the weld seam.

3. A method according to claim 1, wherein the deoxidizer is embedded in a finely dispersed manner prior to the sintering in the molded body in the area of the later weld seam.

4. A method according to claim 1, wherein the deoxidizer is applied prior to the welding as a coating onto the molded body in the region of the later weld seam.

5. A method according to claim 1, wherein silicon and/or titanium or one of its compounds is used as a deoxidizer.

6. A method according to claim 1, wherein the molded body is molten with the help of a defocused laser beam

7. A method according to claim 1, wherein the sintered molded body is cleaned prior to welding by a heat treatment in a reducing protective gas atmosphere or in a low-oxygen atmosphere.
